(19) United States
(12) Patent Application Publication
(10) Pub. No.: US 2025/0265754 A1
(43) Pub. Date: Aug. 21, 2025

(54) DISPLAY CONTROL SYSTEM AND DISPLAY CONTROL METHOD

(71) Applicant: Panasonic Automotive Systems Co., Ltd., Kanagawa (JP)

(72) Inventors: Chikara YOSHIDA, Kanagawa (JP); Seiichi NAKAGAWA, Kanagawa (JP); Takafumi NOGUCHI, Tokyo (JP); Atsushi NAGAMI, Kanagawa (JP)

(73) Assignee: Panasonic Automotive Systems Co., Ltd., Kanagawa (JP)

(21) Appl. No.: 19/056,031

(22) Filed: Feb. 18, 2025

(30) Foreign Application Priority Data
Feb. 20, 2024 (JP) 2024-023771

(51) Int. Cl. G06T 11/60; G06T 11/00

(52) U.S. Cl. CPC G06T 11/60; G06T 11/001

(57) ABSTRACT

A GUIApp of an IVI processor passes, to a GUI framework, data of a first GUI object using a GUI component prepared in advance and data of a second GUI object that designates transparency of the first GUI object to be displayed while being superimposed on a meter image. The GUI framework generates a first image that designates color information to be displayed while being superimposed on the meter image based on the data of the first GUI object, and generates a second image that designates transparency of the first image based on the data of the second GUI object. A video compositor of a meter processor generates a composite image in which the first image whose transparency is set based on the second image is superimposed on the meter image.

### CROSS-REFERENCE TO RELATED APPLICATION

This application is based upon and claims the benefit of priority from the prior Japanese Patent Application No. 2024-023771, filed on Feb. 20, 2024, the entire contents of which are incorporated herein by reference.

### BACKGROUND

### 1. Field

The present disclosure relates to a data processing technology, and more particularly, to a display control system and a display control method.

### 2. Description of the Related Art

The patent document 1 below describes an image integration unit that combines images generated by a plurality of application units and outputs the composite image to a plurality of displays. The image integration unit includes a controller that controls which screen of an application unit is displayed on each display. Each application unit generates pieces of screen data of two or more display modes (such as a normal mode and a simple mode). The controller selectively combines the pieces of screen data according to characteristics of each display, and outputs a combination result to each display.

[patent document 1] WO 2014/118943 A

In a graphical user interface (GUI) framework and a window system generally used in the application unit, setting of outputting transparency information for an output image is limited. Therefore, in a case of combining the output images in the image integration unit, expressiveness of the images to be combined is limited.

### SUMMARY

One object of the present disclosure is to provide a technology for improving expressiveness of a composite image in a system using an application unit in which output of transparency information is limited.

In order to solve the above problem, a display control system according to one aspect of the present disclosure includes: a renderer that generates a first image that designates color information to be displayed while being superimposed on a predetermined image, and a second image that designates transparency of the first image; and a compositor. The renderer generates a first image based on data of a first GUI object using a GUI component prepared in advance, and generates a second image based on data of a second GUI object that outputs an image that designates transparency of the first GUI object, and the compositor generates a composite image in which the first image whose transparency is set based on the second image is superimposed on a predetermined image.

Another aspect of the present disclosure is a display control method. The method is executed by a computer and includes: first processing of generating a first image that designates color information to be displayed while being superimposed on a predetermined image and a second image that designates transparency of the first image; and second processing of generating a composite image in which the first image whose transparency is set based on the second image is superimposed on the predetermined image, in which in the first processing, the first image is generated based on data of a first GUI object using a GUI component prepared in advance, and the second image is generated based on data of a second GUI object that outputs an image that designates transparency of the first GUI object.

Note that arbitrary combinations of the above constituent elements and modifications of the expressions of the present disclosure in apparatuses, computer programs, recording media recording computer programs, and the like are also effective as aspects of the present disclosure.

### BRIEF DESCRIPTION OF THE DRAWINGS

FIG. 1 is a block diagram illustrating functional blocks of a display control system according to an embodiment;

FIG. 2 is a diagram illustrating an example of display graphical user interface (GUI) data;

FIG. 3 is a diagram illustrating an example of layout information;

FIG. 4 is a diagram illustrating an example of a composite image according to a related art;

FIG. 5 is a flowchart illustrating an operation of an in-vehicle infotainment (IVI) device;

FIG. 6 is a diagram illustrating an example of transparency-added GUI data;

FIG. 7 is a diagram illustrating the example of the transparency-added GUI data;

FIG. 8 is a diagram illustrating an example of a transparency-added GUI image;

FIG. 9 is a diagram illustrating an example of the layout information;

FIG. 10 is a flowchart illustrating an operation of a meter device;

FIG. 11 is a diagram illustrating an example of a composite image according to the embodiment; and

FIG. 12 is a diagram illustrating an example of a transparency-added GUI image according to a modified example.

### DETAILED DESCRIPTION OF THE EMBODIMENTS

The invention will now be described by reference to the preferred embodiments. This does not intend to limit the scope of the present invention, but to exemplify the invention.

A subject of an apparatus or method in the present disclosure includes a computer. The computer executes a program, thereby implementing functions of the subject of the apparatus or method in the present disclosure. The computer includes a processor that operates according to the program as a main hardware configuration. A type of the processor is not limited as long as the processor can implement the functions by executing the program. The processor includes one or more electronic circuits including a semiconductor integrated circuit (IC) or a large scale integration (LSI). Although the electronic circuits are referred to as the IC or the LSI here, the terms vary depending on the degree of integration, and may be referred to as a system LSI, a very large scale integration (VLSI), or an ultra large scale integration (ULSI). A field programmable gate array (FPGA), which is programmed after manufacturing of the LSI, or a reconfigurable logic device capable of reconfiguring a bonding relationship inside the LSI or setting up a circuit section inside the LSI can also be used for the same purpose. The plurality of electronic circuits may be integrated on one chip or may be provided on a plurality of chips. The plurality of chips may be integrated into one apparatus or may be provided in a plurality of apparatuses. The program may be recorded in a non-transitory recording medium such as a computer-readable read only memory (ROM), an optical disk, or a hard disk drive, or may be recorded in a transitory storage medium such as a computer-readable random access memory (RAM). The program may be stored in advance in a recording medium, or may be supplied to a recording medium or a storage medium via a wide area communication network including the Internet or the like.

A display control system according to an embodiment is a system including two or more processors mounted on physically different units. The two or more processors include an in-vehicle infotainment (IVI) side processor and a meter side processor. The IVI side processor includes a general operating system (OS) for IVI and a graphical user interface (GUI) application that operates on the OS. The OS includes a GUI framework and a window system. The GUI application uses the GUI framework and the window system to generate an IVI image (for example, an image indicating navigation information) to be displayed on a display of a meter. The window system transmits the IVI image to a meter side.

The IVI image according to the embodiment includes a color information region (a display GUI image described below) in which color information of a GUI object is rendered and a transparency region (a transparency GUI image described below) in which transparency is rendered as color information. The meter side processor combines an image of the color information region whose transparency is set based on the color information of the transparency region with an image of the meter. The “image” in the embodiment includes one or both of a video (moving image) and a still image.

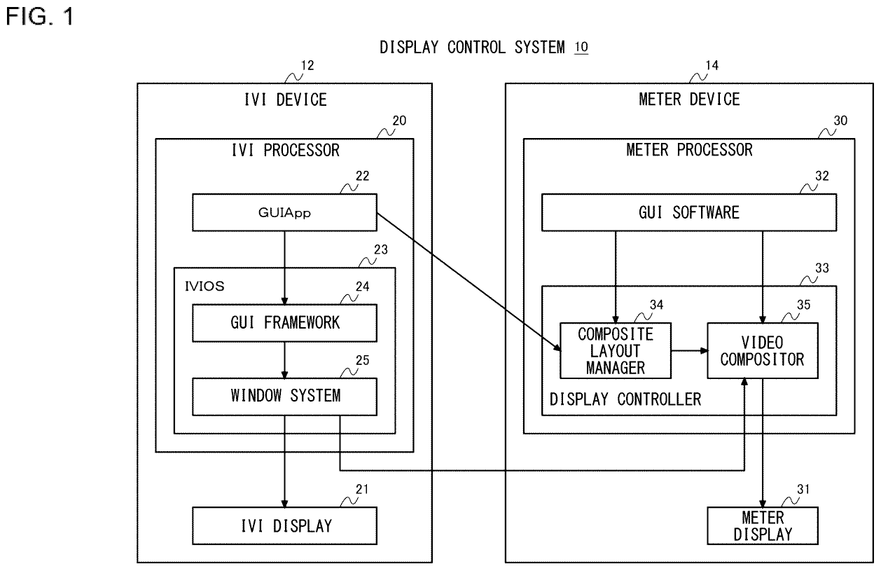

FIG. 1 is a block diagram illustrating functional blocks of a display control system 10 according to the embodiment. Each block illustrated in the block diagram according to the present disclosure can be implemented by an element such as a central processing unit (CPU) or a memory of a computer or a mechanical apparatus in terms of hardware, and is implemented by a computer program or the like in terms of software, but here, functional blocks implemented by a combination thereof are illustrated. It is understood by those skilled in the art that the functional blocks can be implemented in various forms by a combination of hardware and software.

The display control system 10 is a data processing system constructed in a vehicle. The display control system 10 includes an IVI device 12 and a meter device 14. The IVI device 12 is an in-vehicle information device that executes processing such as navigation, streaming of a moving image, and music reproduction. The meter device 14 is a device that executes processing related to display of the meter of the vehicle, such as a speedometer or an engine tachometer. The IVI device 12 and the meter device 14 have different safety requirements. That is, the meter device 14 is required to have higher safety than the IVI device 12. Safety refers to not only security but also robustness or accuracy of information.

The IVI device 12 and the meter device 14 transmit and receive a video signal by using a general-purpose video transmission interface such as a gigabit video interface (GVIF) (registered trademark), a high-definition multimedia interface (HDMI) (registered trademark), or a gigabit multimedia serial link (GMSL). The IVI device 12 and the meter device 14 transmit and receive a message (for example, layout information) by using a data transmission interface such as TCP/IP different from the video transmission interface.

The IVI device 12 includes an IVI processor 20 and an IVI display 21. The IVI processor 20 executes various types of data processing in the IVI device 12. The IVI processor 20 includes a CPU and a memory. The IVI processor 20 may be implemented as an electronic control unit (ECU) or a system on a chip (SoC). The IVI display 21 displays the IVI image output from the IVI processor 20. The IVI image may include, for example, a navigation image or a streamed video.

The IVI processor 20 includes a GUIApp 22 and an IVIOS 23. A function of each functional block in the IVI processor 20 may be implemented in a computer program. The IVI processor 20 may perform the function of each functional block by executing the computer program.

The IVIOS 23 is a general OS (in other words, system software) introduced into the IVI processor 20. The IVIOS 23 includes a GUI framework 24 and a window system 25. The GUIApp 22 is a GUI application that operates on the IVIOS 23 and generates an image related to IVI. The IVIOS 23 (GUI framework 24) does not store transparency information in rendering data. In addition, since the IVIOS 23 is a ready-made product, it is not possible to add a new function such as storing the transparency information in the rendering data.

The meter device 14 includes a meter processor 30 and a meter display 31. The meter processor 30 executes various types of data processing in the meter device 14. The meter processor 30 includes a CPU and a memory. The meter processor 30 may be implemented as an ECU or an SoC. The meter display 31 displays images of various meters output from the meter processor 30.

The meter processor 30 includes a GUI software 32 and a display controller 33. A function of each functional block in the meter processor 30 may be implemented in a computer program. The meter processor 30 may perform the function of each functional block by executing the computer program.

The GUI software 32 generates the images of various meters. The images of the meters include, for example, an image of the speedometer and an image of the engine tachometer. The GUI software 32 may include a GUI application, a GUI framework, and a window system. The display controller 33 controls display contents of the meter display 31. The display controller 33 causes the meter display 31 to display a meter image output from the GUI software 32.

The display control system 10 according to the embodiment causes the meter display 31 to display a composite image obtained by combining a GUI image for IVI generated by the IVI processor 20 with the meter image generated by the meter processor 30. First, a configuration related to display of a composite image according to a related art will be described.

The GUIApp 22 of the IVI processor 20 as a generator generates data of the GUI object related to IVI to be displayed while being superimposed on the meter image (hereinafter, also referred to as “display GUI data”). The display GUI data is data of the GUI object using a GUI component prepared in advance. In the embodiment, the GUI component prepared in advance is a GUI component defined in hypertext markup language (HTML). The display GUI data according to the embodiment is data using one or more GUI components (for example, a container and a button) selected by a developer (a screen designer or the like) from among a plurality of GUI components defined by HTML. The display GUI data may be an HTML document. The GUIApp 22 outputs the display GUI data to the GUI framework 24.

The GUI framework 24 of the IVI processor 20 as a renderer generates data of the display GUI image based on the display GUI data output from the GUIApp 22. The GUI framework 24 includes, for example, an HTML rendering engine. The display GUI image is an image to be combined with the meter image, and includes the GUI object indicating information regarding IVI. The data of the display GUI image includes a pixel value of the GUI object.

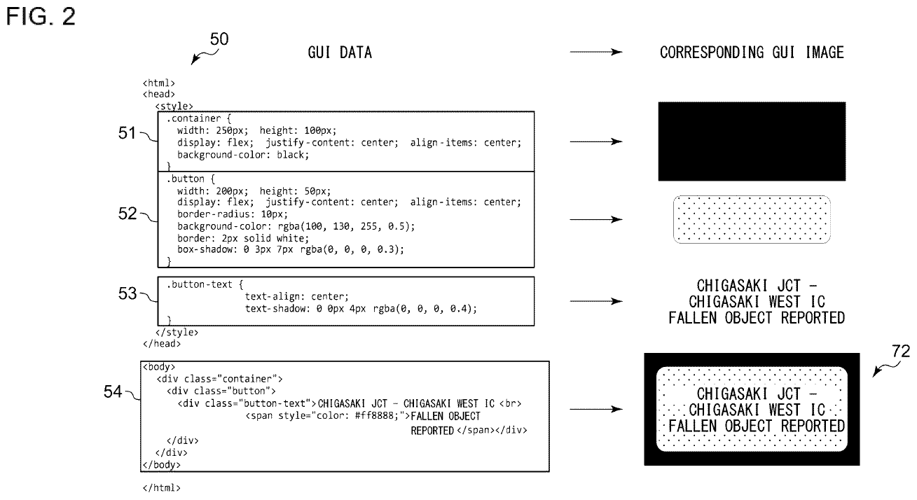

FIG. 2 illustrates an example of the display GUI data. Display GUI data 50 includes container style data 51, button style data 52, text style data 53, and content data 54. The container style data 51 is data that defines a style of a container object. The button style data 52 is data that defines a style of a button object. The text style data 53 is data that defines a style of text. The content data 54 is data that designates a content to be displayed on a screen (that is, a display GUI image 72).

Returning to FIG. 1, the window system 25 of the IVI processor 20 includes a frame buffer that temporarily stores image data. The GUI framework 24 stores the generated data of the display GUI image in the frame buffer. The window system 25 transmits the data of the display GUI image stored in the frame buffer to the meter device 14 via the video transmission interface.

In addition, the GUIApp 22 of the IVI processor 20 further generates the layout information that designates a display mode of the display GUI image on the meter display 31. The GUIApp 22 transmits the layout information to the meter device 14 via the data transmission interface different from the video transmission interface.

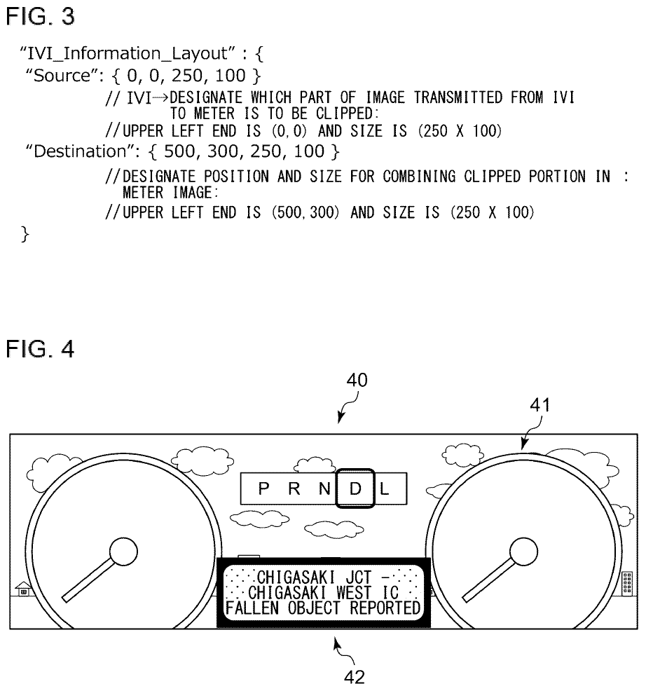

FIG. 3 illustrates an example of the layout information. The layout information includes a source attribute and a destination attribute. The source attribute is information that designates a position of a clipping region. For example, the source attribute includes a horizontal coordinate and a vertical coordinate of an upper left end of the display GUI image in the image data input from the IVI device 12 to the meter device 14, and a size (a horizontal width and a vertical width) of the display GUI image. The destination attribute is information that designates a position to be combined. For example, the destination attribute includes a horizontal coordinate and a vertical coordinate of an upper left end of a region to be combined with the IVI image in the meter image, and a size (a horizontal width and a vertical width) of the region to be combined.

The GUI software 32 of the meter device 14 generates images of various meters. The GUI software 32 further generates layout information that defines a display mode of the meter image. The display controller 33 of the meter device 14 includes a composite layout manager 34 and a video compositor 35. The GUI software 32 outputs data of the meter image to the video compositor 35 and outputs the layout information to the composite layout manager 34.

The composite layout manager 34 acquires the layout information of the IVI image transmitted from the IVI processor 20 via the data transmission interface. In addition, the composite layout manager 34 acquires the layout information of the meter image output from the GUI software 32. The composite layout manager 34 inputs the layout information of the IVI image and the layout information of the meter image to the video compositor 35.

The video compositor 35 as a compositor generates data of the composite image in which the IVI image (for example, the display GUI image 72) transmitted from the IVI processor 20 via the video transmission interface is superimposed on the meter image output from the GUI software 32. The video compositor 35 may generate the composite image by using a known alpha blend. The video compositor 35 outputs data of the composite image to the meter display 31, and displays the composite image on the meter display 31.

FIG. 4 illustrates an example of a composite image according to a related technology. A composite image 40 includes a meter image 41 and an IVI image 42. The IVI image 42 corresponds to the display GUI image 72 of FIG. 2. In the related technology, it is difficult to set transparency for the IVI image 42, and there is a limitation on expressiveness of the composite image 40. As described above, the IVIOS 23, which is an OS generally used in the IVI device 12, does not store the transparency information in the rendering data. Therefore, the video compositor 35 has to combine the opaque IVI image 42 with the meter image 41. In addition, even in a case where the transparency can be set for the entire IVI image 42, the transparency cannot be set in units of pixels, and thus, the expressiveness of the composite image 40 is insufficient.

Therefore, in the embodiment, a technology for improving the expressiveness of the composite image in a case of using a system (for example, the IVIOS 23) in which the setting of the transparency is limited is proposed. Referring back to FIG. 1, features of each functional block in the display control system 10 according to the embodiment will be described.

The GUIApp 22 of the IVI processor 20 holds data of a first GUI object related to IVI to be displayed while being superimposed on the meter image (hereinafter, also referred to as “display GUI data”). At the same time, the GUIApp 22 also holds data of a second GUI object that designates transparency of the first GUI object (hereinafter, also referred to as “transparency GUI data”). Both the display GUI data and the transparency GUI data are data of the GUI objects using the GUI components (for example, the container and the button) prepared in advance by HTML. In the embodiment, the display GUI data and the transparency GUI data use GUI components of the same type. As a modified example, the display GUI data and the transparency GUI data may use different types of GUI components. The transparency GUI data may designate the transparency of the first GUI object indicated by the display GUI data by using the GUI component different from the GUI component used by the display GUI data. In addition, in the IVI processor 20, another GUI component used by the transparency GUI data may be prepared and stored separately from the GUI component used by the display GUI data. The transparency GUI data may designate the transparency of the first GUI object indicated by the display GUI data by using another GUI component.

The data of the first GUI object (display GUI data) and the data of the second GUI object (transparency GUI data) may be stored in advance in the GUIApp 22. In addition, the GUIApp 22 may dynamically generate the display GUI data and the transparency GUI data according to an operation state of the IVI device 12. The transparency designated by the transparency GUI data can be said to be the transparency of the first GUI object (in other words, the IVI image) when the first GUI object (in other words, the IVI image) is superimposed on the meter image.

The GUI framework 24 of the IVI processor 20 generates an image of the first GUI object (hereinafter, also referred to as “display GUI image”) based on the display GUI data. The display GUI image is a first image that designates color information to be displayed while being superimposed on a superimposition target image (the meter image in the embodiment). The GUI framework 24 further generates an image of the second GUI object (hereinafter, also referred to as “transparency GUI image”) based on the transparency GUI data. The transparency GUI image is a second image that designates transparency of the display GUI image when the display GUI image is superimposed on the meter image. The video compositor 35 of the meter processor 30 generates a composite image in which the display GUI image whose transparency is set based on the image of the transparency GUI image is superimposed on the meter image.

In the embodiment, the GUIApp 22 generates data of a third GUI object including the display GUI data and the transparency GUI data (hereinafter, also referred to as “transparency-added GUI data”). The GUIApp 22 further generates layout information including a position of the second GUI object (transparency GUI image) in the third GUI object (transparency-added GUI image described below).

The GUI framework 24 generates an image of the third GUI object (hereinafter, also referred to as “transparency-added GUI image”) based on the transparency-added GUI data. The transparency-added GUI image is one image obtained by integrating the display GUI image and the transparency GUI image, and is one image in which the display GUI image and the transparency GUI image are disposed in different regions. The video compositor 35 extracts the display GUI image and the transparency GUI image from the transparency-added GUI image based on the layout information.

An operation of the display control system 10 having the above configuration will be described.

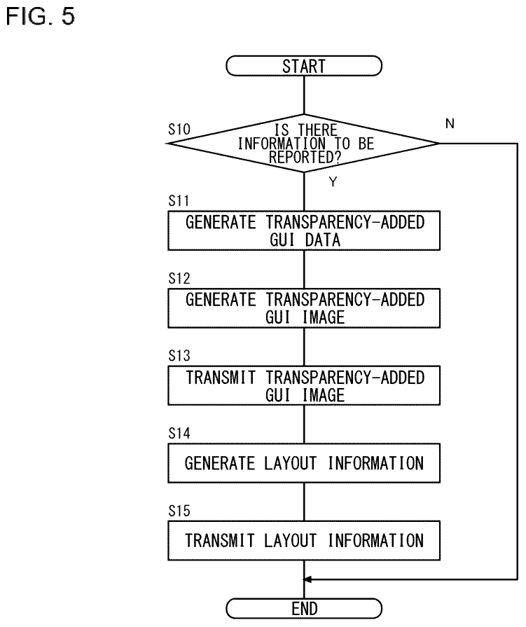

FIG. 5 is a flowchart illustrating an operation of the IVI device 12. In a case where information (for example, navigation information) to be reported to an occupant of the vehicle by being displayed on the meter display 31 is generated (Y in S10), the GUIApp 22 of the IVI processor 20 generates the transparency-added GUI data (S11).

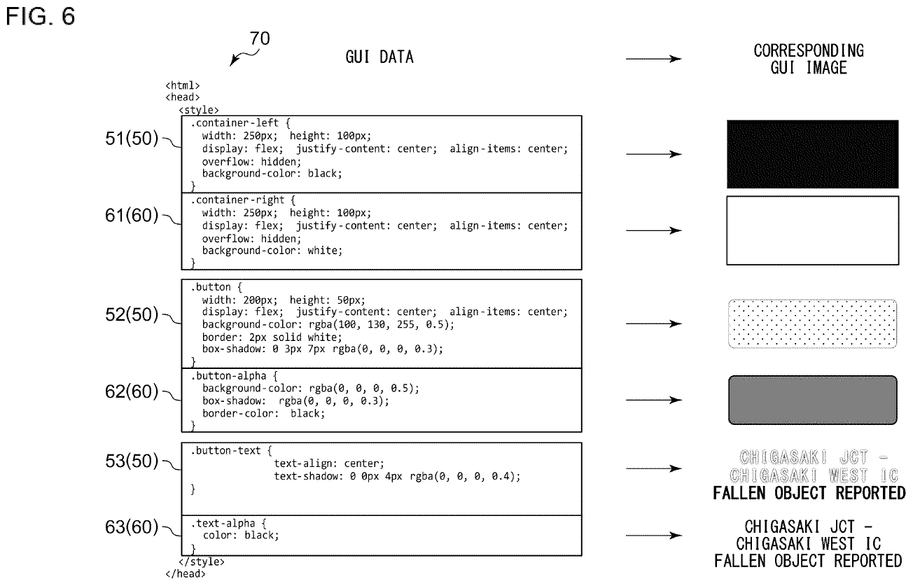

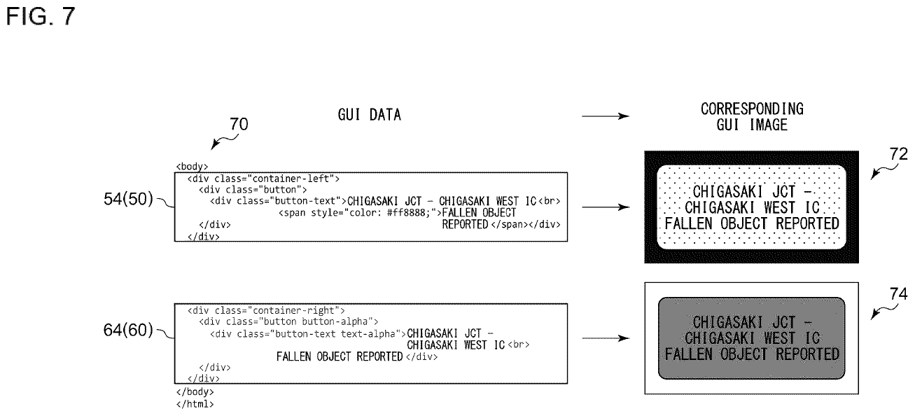

FIGS. 6 and 7 illustrate an example of the transparency-added GUI data. FIG. 6 illustrates a header portion of an HTML document as the transparency-added GUI data, and FIG. 7 illustrates a body portion of the HTML document as the transparency-added GUI data. Transparency-added GUI data 70 includes the display GUI data 50 (the container style data 51, the button style data 52, the text style data 53, and the content data 54) described above with reference to FIG. 2. The information to be reported to the occupant of the vehicle is set in the content data 54.

Further, the transparency-added GUI data 70 further includes transparency GUI data 60. The transparency GUI data 60 includes container style data 61 corresponding to the container style data 51, button style data 62 corresponding to the button style data 52, text style data 63 corresponding to the text style data 53, and content data 64 corresponding to the content data 54. A black outer frame is drawn in a GUI image corresponding to the container style data 61, but there is actually no outer frame. The content data 64 is data for setting an image (that is, transparency GUI image 74) that designates transparency of the display GUI image 72.

The transparency GUI data 60 according to the embodiment is a GUI object having the same shape as the GUI object of the display GUI data 50, and is data that defines a monochrome GUI object. In the embodiment, the GUI object of the transparency GUI data 60 is set such that the lower the transparency of the GUI object of the corresponding display GUI data 50, the darker the color becomes. In other words, the GUI object of the transparency GUI data 60 is set such that the higher the transparency of the GUI object of the corresponding display GUI data 50, the whiter the color becomes. As a modified example, contrary to the embodiment, the GUI object of the transparency GUI data 60 may be set such that the lower the transparency of the GUI object of the corresponding display GUI data 50, the whiter the color becomes.

In the example of FIG. 6, “background-color” of the container style data 61 is set to white in order to transparently display the container object defined by the container style data 51. Furthermore, an a value is set to 0.5 in “background-color” of the button style data 62 in order to translucently display the button object defined by the button style data 52. In the embodiment, the GUIApp 22 is implemented so as to generate the transparency GUI image 74 reflecting the transparency to be set for the display GUI image 72 from the viewpoint of design.

Returning to FIG. 5, the GUI framework 24 of the IVI processor 20 analyzes the HTML document as the transparency-added GUI data, and generates the transparency-added GUI image which is an image based on the transparency-added GUI data (S12). The window system 25 of the IVI processor 20 transmits the transparency-added GUI image to the meter device 14 via the video transmission interface (S13).

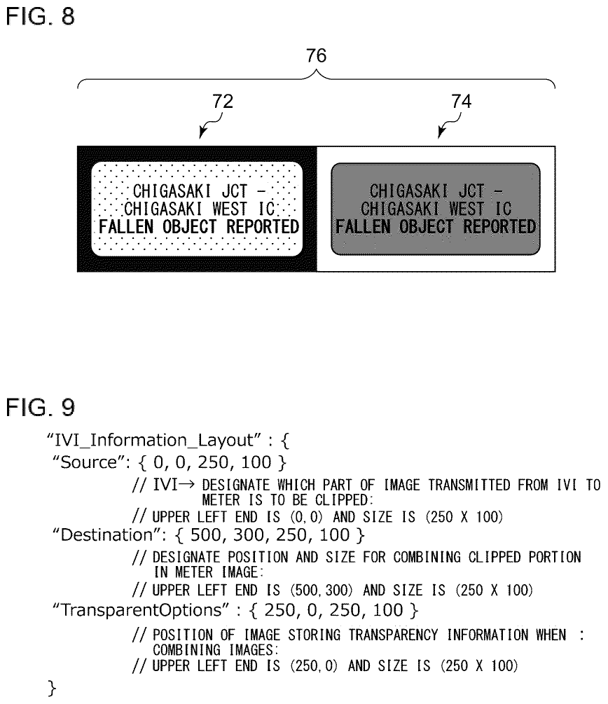

FIG. 8 illustrates an example of the transparency-added GUI image. A transparency-added GUI image 76 includes the display GUI image 72 and the transparency GUI image 74. The transparency-added GUI image 76 in the embodiment is an image in which the display GUI image 72 and the transparency GUI image 74 are arranged side by side. In the example of FIG. 8, an outer edge portion of the display GUI image 72 is black, and an outer edge portion of the transparency GUI image 74 is white. Therefore, the outer edge portion of the display GUI image 72 is displayed with high transparency, and is treated as being transparent, for example.

Returning to FIG. 5, the GUIApp 22 of the IVI processor 20 generates layout information related to the transparency-added GUI data (transparency-added GUI image) (S14). The GUIApp 22 transmits the layout information generated in S14 to the meter device 14 via the data transmission interface different from the video transmission interface (S15). In a case where the information to be reported to the occupant of the vehicle by being displayed on the meter display 31 is not generated (N in S10), the processing after S11 is skipped. The IVI device 12 repeatedly executes the processing illustrated in FIG. 5. The processing of S11 to S13 and the processing of S14 to S15 may be executed in parallel.

FIG. 9 illustrates an example of the layout information. The layout information related to the transparency-added GUI data (transparency-added GUI image) includes a transparency option attribute (TransparentOptions) in addition to the source attribute and the destination attribute illustrated in the layout information of FIG. 3. The transparency option attribute includes a horizontal coordinate and a vertical coordinate of an upper left end of the transparency GUI image in the transparency-added GUI image, and a size (a horizontal width and a vertical width) of the transparency GUI image. The layout information added with the transparency option attribute can also be said to be information indicating that an image added with the transparency information (transparency GUI image) is transmitted.

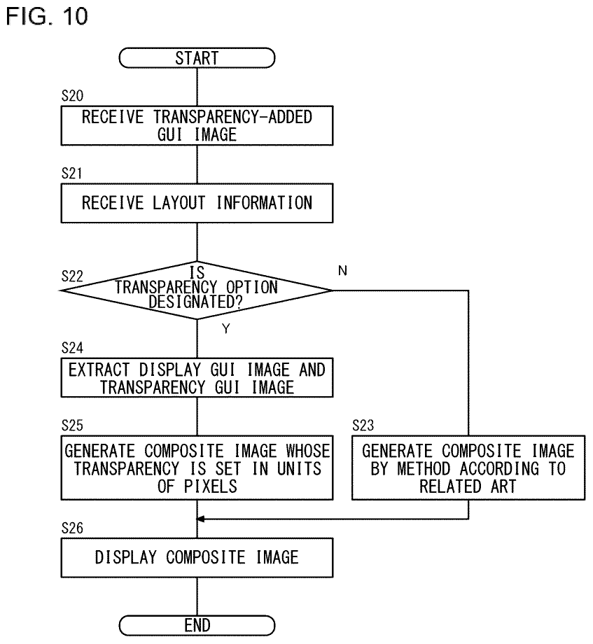

FIG. 10 is a flowchart illustrating an operation of the meter device 14. The video compositor 35 of the meter processor 30 acquires the meter image generated by the GUI software 32 of the meter processor 30. Further, the video compositor 35 receives the transparency-added GUI image transmitted from the IVI device 12 via the video transmission interface (S20).

The composite layout manager 34 of the meter processor 30 acquires the layout information generated by the GUI software 32 of the meter processor 30. In addition, the composite layout manager 34 receives the layout information transmitted from the IVI device 12 via the data transmission interface (S21). The composite layout manager 34 passes the acquired or received layout information to the video compositor 35.

In a case where the transparency option attribute is designated in the layout information transmitted from the IVI device 12, the video compositor 35 detects the designation. In a case where the transparency option attribute is not designated in the layout information transmitted from the IVI device 12 (N in S22), the video compositor 35 generates the composite image obtained by combining the IVI image transmitted from the IVI device 12 with the meter image by a method according to the related art (S23). Specifically, the video compositor 35 extracts the display GUI image from the image data transmitted from the IVI device 12 based on the source attribute of the layout information. The video compositor 35 generates the composite image obtained by combining the display GUI image with a region of the meter image indicated by the destination attribute of the layout information. The video compositor 35 displays the composite image on the meter display 31 (S26).

In a case where the transparency option attribute is designated in the layout information transmitted from the IVI device 12 (Y in S22), the video compositor 35 extracts the display GUI image from the transparency-added GUI image based on the source attribute of the layout information. At the same time, the video compositor 35 extracts the transparency GUI image from the transparency-added GUI image based on the transparency option attribute of the layout information (S24).

The video compositor 35 generates the composite image obtained by combining the display GUI image whose transparency is set in units of pixels based on the transparency GUI image with the region of the meter image indicated by the destination attribute of the layout information (S25). The video compositor 35 displays the composite image on the meter display 31 (S26).

The processing in the video compositor 35 in S25 will be described in detail. Here, RGB pixel values of corresponding pixels between the display GUI image, the transparency GUI image, and the meter image to be combined (the region designated by the destination attribute) are expressed as follows.
RGB pixel values of display GUI image: (S1r, S1g, and S1b)
RGB pixel values of transparency GUI image: (S2r, S2g, and S2b)
RGB pixel values of meter image: (S3r, S3g, and S3b)
RGB pixel values of composite image: (Dr, Dg, and Db)

Transparency α for each pixel is α=1−S2r. Therefore, the video compositor 35 calculates the RGB pixel values of the composite image as follows.

$$Dr = S 3 r \times ( 1 - α ) + S 1 r = S 3 r \times S 2 r + S 1 r$$

$$Dg = S 3 g \times ( 1 - α ) + S 1 g = S 3 g \times S 2 r + S 1 g$$

$$Db = S 3 b \times ( 1 - α ) + S 1 b = S 3 b \times S 2 r + S 1 b$$

Here, formulas in which the pixel value is expressed by 0 to 1 (the closer the pixel value to 0, the darker the color, and the closer the pixel value to 1, the whiter the color) is shown, but as a modified example, the pixel values may be expressed by 0 to 255 (the closer the pixel value to 0, the darker the color, and the closer the pixel value to 255, the whiter the color). The video compositor 35 performs the above calculation on all the pixels to be combined, and calculates each pixel value of the composite image.

In the embodiment, a pixel value multiplied by the transparency in advance is stored in the display GUI image as illustrated in FIG. 6. That is, in the embodiment, in a case where the transparency is designated for the first GUI object in the display GUI data, the GUI framework 24 of the IVI processor 20 generates the display GUI image indicating a color obtained by multiplying a color designated for the first GUI object in the display GUI data by the transparency designated in the display GUI data. As a modified example, a pixel value for which the transparency is not set may be stored in the display GUI image. In this case, the video compositor 35 may calculate the RGB pixel values of the composite image as follows.

$$Dr = S 3 r \times ( 1 - α ) + S 1 r \times α = S 3 r \times S 2 r + S 1 r \times ( 1 - S 2 r )$$

$$Dg = S 3 g \times ( 1 - α ) + S 1 g \times α = S 3 g \times S 2 r + S 1 g \times ( 1 - S 2 r )$$

$$Db = S 3 b \times ( 1 - α ) + S 1 b \times α = S 3 b \times S 2 r + S 1 b \times ( 1 - S 2 r )$$

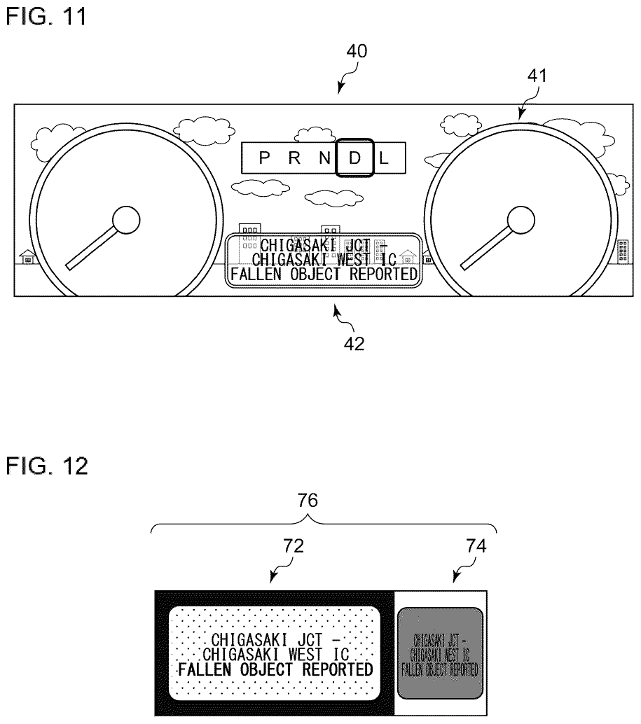

FIG. 11 illustrates an example of the composite image according to the embodiment. The composite image 40 according to the embodiment includes the IVI image 42 (the above composite image) whose transparency is set. For example, in the IVI image 42, the transparency is set for a container image and a button image, and the meter image 41 as a background can be seen through. On the other hand, frames of text and the button image are displayed in an opaque manner.

With the display control system 10 according to the embodiment, it is possible to improve the expressiveness of the composite image to be displayed on the meter display 31 even in a case of using the IVIOS 23 (GUI framework 24) in which the setting of the transparency is limited. In the display control system 10, the transparency of the composite image can be designated in units of pixels, and the transparency can be set only for a part of the composite image. Furthermore, in the display control system 10, the transparency can also be set for a non-rectangular object such as a rounded square.

In addition, with the display control system 10 according to the embodiment, in a case where the processor of the meter device 14 having a relatively high safety requirement combines the image generated by the processor of the IVI device 12 having a relatively low safety requirement with the meter image, the expressiveness of the composite image can be improved. In addition, with the display control system 10, the display GUI image and the transparency GUI image can be extracted from the transparency-added GUI image for IVI by using an existing mechanism of generating the composite image based on the layout information.

The present disclosure has been described above based on the embodiment. It is to be understood by those skilled in the art that the embodiment is an example, various modified examples can be made for combinations of the constituent elements or processing processes of the embodiment, and such modified examples are also within the scope of the present disclosure.

A first modified example will be described. The GUI framework 24 of the IVI device 12 according to the embodiment includes the HTML rendering engine. As a modified example, the GUI framework 24 may include other types of rendering engines. For example, the GUI framework 24 may include a Flutter (trade mark or registered trademark) rendering engine or may include an Android (trade mark or registered trademark) rendering engine. The GUIApp 22 of the IVI processor 20 may generate the transparency-added GUI data in a format corresponding to a type of rendering engine used by the GUI framework 24.

A second modified example will be described. In the embodiment, the display GUI image and the transparency GUI image use the same plurality of GUI components. As a modified example, the display GUI image and the transparency GUI image may have different configurations of GUI components. The GUIApp 22 of the IVI processor 20 may generate the transparency GUI data in which some GUI components that are not related to the transparency among the plurality of GUI components used by the display GUI image are not set in the transparency GUI image.

For example, in a case where there is an opaque frame object (a button or the like) and characters are displayed without transparency inside the frame object, it is not necessary to reflect, in the transparency GUI image, the transparency of the characters inside the frame object. In this case, it is sufficient if a black frame object (that is, an object instructed to be opaque) is set in the transparency GUI image. According to the modified example, it is possible to reduce a load of processing of generating the transparency GUI image in the IVI processor 20.

A third modified example will be described. In the embodiment, the GUIApp 22 of the IVI processor 20 is implemented to generate the transparency-added GUI data including the display GUI data and the transparency GUI data corresponding to the display GUI data. As a modified example, the GUIApp 22 may have a function of automatically generating at least a part of the transparency GUI data based on the display GUI data (here, referred to as an “additional data setter”).

The additional data setter may generate the transparency GUI data including data of the same GUI component as a GUI component (a container, a button, or the like) set in the display GUI data. At that time, the a value of “background-color” of the corresponding GUI component of the display GUI data may be set as “background-color” of the GUI component of the transparency GUI data. According to the modified example, it is possible to reduce a burden on the developer of the GUIApp 22 to manually implement the GUIApp 22 so as to generate the transparency GUI data corresponding to the display GUI data. The developer may add attribute information indicating whether or not each GUI component needs to be reflected in the transparency GUI data to the display GUI data such that the additional data setter can identify a GUI component desired to be reflected in the transparency GUI data and a GUI component that is not desired to be reflected in the transparency GUI data.

A fourth modified example will be described. In the embodiment, the layout information is described in a Javascript Object Notation (JSON) format (“JavaScript” is a trademark or a registered trademark), but the layout information may be described in another format. Furthermore, in the layout information according to the embodiment, the position and size of the IVI image are designated in units of pixels in the meter device 14. However, the position and size of the IVI image may be designated with more abstract values. For example, in the layout information, designation such as displaying a percentage position at which the IVI image is to be displayed on a screen (or on the meter image) may be made. Further, the composite layout manager 34 of the meter processor 30 may be configured to calculate a specific display position of the IVI image.

A fifth modified example will be described. In the embodiment, the display GUI image and the transparency GUI image have the same resolution. On the other hand, the transparency information is lower in importance than the color information, and thus, the resolution of the transparency GUI image may be lower than the resolution of the display GUI image. In other words, the GUIApp 22 of the IVI processor 20 may generate the transparency-added GUI data including the transparency GUI data for generating the transparency GUI image having a lower resolution than the display GUI image. According to the modified example, an amount of image data transferred from the IVI processor 20 to the meter processor 30 can be reduced.

FIG. 12 illustrates an example of the transparency-added GUI image according to the modified example. FIG. 12 illustrates an example in which a horizontal resolution of the transparency GUI image 74 is set to ¼ of a horizontal resolution of the display GUI image 72. A vertical resolution of the transparency GUI image 74 is the same as a vertical resolution of the display GUI image 72. In the modified example, the video compositor 35 of the meter processor 30 may associate one pixel of the transparency GUI image 74 with a plurality of pixels of the display GUI image 72. In the example of FIG. 12, the video compositor 35 may associate one pixel of the transparency GUI image 74 in a horizontal direction with four pixels of the display GUI image 72 in the horizontal direction.

A sixth modified example will be described. The GUIApp 22 of the IVI processor 20 may generate the transparency-added GUI data including the transparency GUI data for generating the transparency GUI images with chromatic colors other than black and white. As a result, it is possible to obtain a composite image with an effect similar to applying a color filter, which cannot be obtained using the transparency GUI image with colors of only black and white. For example, it is possible to apply a bluish tint to the composite image by using the transparency GUI image filled with blue. In addition, it is possible to apply a reddish tint to the composite image by using the transparency GUI image filled with red.

In the embodiment, the video compositor 35 of the meter processor 30 uses a pixel value (S2r) of an R channel of the transparency GUI image as transparency of a composite of all the RGB channels. In the present modified example, as in the following formula, the RGB pixel values (S2r, S2g, and S2b) of the transparency GUI image may be used as the transparency of the composite of the respective channels.

$$Dr = S 3 r \times ( 1 - α ) + S 1 r = S 3 r \times S 2 r + S 1 r$$

$$Dg = S 3 g \times ( 1 - α ) + S 1 g = S 3 g \times S 2 g + S 1 g$$

$$Db = S 3 b \times ( 1 - α ) + S 1 b = S 3 b \times S 2 b + S 1 b$$

A seventh modified example will be described. In the embodiment, the video compositor 35 of the meter processor 30 calculates the RGB pixel values (Dr, Dg, and Db) of the composite image as follows.

$$Dr = S 3 r \times S 2 r + S 1 r$$

$$Dg = S 3 g \times S 2 r + S 1 g$$

$$Db = S 3 b \times S 2 r + S 1 b$$

In the calculation, in a case where a calculation result of each channel exceeds 1 (also referred to as maximum pixel value), processing (also referred to as saturation computation) of setting the result to 1 may be executed.

In the modified example, the IVI processor 20 can transmit the transparency-added GUI image including the display GUI image and the transparency GUI image in which the RGB pixel values after the combination exceed 1 to the meter processor 30. In a typical transparency GUI image in the modified example, the value of S2r is set to 1. According to the modified example, the composite image obtained by adding light to the meter image can be obtained.

An eighth modified example will be described. In the embodiment, a first processor (that is, the IVI processor 20) that generates the first image to be combined and a second processor (that is, the meter processor 30) that generates the second image to be combined are stored in separate units. As a modified example, the IVI processor 20 and the meter processor 30 may be stored in a single unit. In this case, the image data and the layout information may be transmitted and received between the IVI processor 20 and the meter processor 30 by sharing a memory space between the IVI processor 20 and the meter processor 30.

In addition, both the IVI processor 20 and the meter processor 30 may be virtual processors. A single physical processor may execute both the processing in the IVI processor 20 and the processing in the meter processor 30. In other words, the functions of the IVI processor 20 (for example, the GUIApp 22, the GUI framework 24, and the window system 25) and the functions of the meter processor 30 (for example, the GUI software 32, the composite layout manager 34, and the video compositor 35) may be implemented in a single physical processor. The single physical processor may include a first OS (here, referred to as “IVIOS”) on which the functions of the IVI processor 20 operate, and a second OS (here, referred to as “meter OS”) on which the functions of the meter processor 30 operate. The meter OS typically has a different safety requirement than that of the IVIOS, and specifically has a higher safety requirement than that of the IVIOS. In this case, a memory shared by multiple virtual processors may be used to transmit and receive the image data and the layout information between the IVI processor 20 and the meter processor 30.

Any combination of the plurality of embodiments and the plurality of modified examples described above is also useful as an embodiment of the present disclosure. A new embodiment generated by the combination has the effect of each of the combined embodiments and modified examples. In addition, it will be understood by those skilled in the art that the functions to be performed by the constituent elements described in the claims are implemented by a single constituent element or cooperation of the constituent elements described in the embodiments and the modified examples.

### Supplementary Note

The following technologies are disclosed by the description of the above embodiments and modified examples.

### [Technology 1]

A display control system including:
a renderer structured to generate a first image that designates color information to be displayed while being superimposed on a predetermined image and a second image that designates transparency of the first image; and
a compositor, in which
the renderer generates the first image based on data of a first graphical user interface (GUI) object using a GUI component prepared in advance, and generates the second image based on data of a second GUI object that outputs an image that designates transparency of the first GUI object, and
the compositor generates a composite image in which the first image whose transparency is set based on the second image is superimposed on the predetermined image.

With the display control system, the expressiveness of the composite image can be improved in a system using an application unit (for example, the renderer) in which output of the transparency information is limited.

### [Technology 2]

The display control system according to Technology 1, in which the renderer generates the first image indicating a color obtained by multiplying a color designated for the first GUI object by predetermined transparency.

With the display control system, the expressiveness of the composite image can be further improved.

### [Technology 3]

The display control system according to Technology 1 or 2, in which the renderer generates one image in which the first image and the second image are disposed in different regions as one image to be transmitted to the compositor.

With the display control system, the number of times image transmission/reception is performed between the processor on the renderer side (for example, the IVI processor 20) and the processor on the compositor side (for example, the meter processor 30) can be reduced.

### [Technology 4]

The display control system according to Technology 3, further including a generator structured to generate layout information including a position of the second image in the one image,
in which the compositor extracts the first image and the second image from the one image based on the layout information.

With the display control system, the first image and the second image can be extracted from the one image by using an existing mechanism for generating the composite image based on the layout information.

### [Technology 5]

The display control system according to any one of Technologies 1 to 4, in which
the renderer is implemented in a first processor, and
the compositor is implemented in a second processor having a safety requirement different from a safety requirement of the first processor.

With the display control system, in a case where the second processor having a safety requirement different from that of the first processor generates the composite image by using the image generated by the first processor, the expressiveness of the composite image can be improved.

### [Technology 6]

The display control system according to any one of Technologies 1 to 4, in which
the renderer and the compositor are implemented in a single processor,
the single processor includes a first operating system (OS) on which the renderer operates and a second OS on which the compositor operates, and
the second OS has a safety requirement different from a safety requirement of the first OS.

With the display control system, in a case where the compositor operating on the second OS having a safety requirement different from that of the first OS generates the composite image by using the image generated by the renderer operating on the first OS, the expressiveness of the composite image can be improved.

### [Technology 7]

The display control system according to any one of Technologies 1 to 4, in which
the renderer is implemented in a processor of an information device mounted on a vehicle, and
the compositor is implemented in a processor of a meter device mounted on the vehicle.

With the display control system, in a case where the processor of the meter device generates the composite image by using the image generated by the processor of the information device, the expressiveness of the composite image can be improved.

### [Technology 8]

A display control method executed by a computer, the display control method including:
first processing of generating a first image that designates color information to be displayed while being superimposed on a predetermined image and a second image that designates transparency of the first image; and
second processing of generating a composite image in which the first image whose transparency is set based on the second image is superimposed on the predetermined image,
in which in the first processing, the first image is generated based on data of a first GUI object using a GUI component prepared in advance, and the second image is generated based on data of a second GUI object that outputs an image that designates transparency of the first GUI object.

With the display control method, the expressiveness of the composite image can be improved in the system using the application unit in which the output of the transparency information is limited.

While various embodiments have been described herein above, it is to be appreciated that various changes in form and detail may be made without departing from the spirit and scope of the invention(s) presently or hereafter claimed.

### CROSS-REFERENCE TO RELATED APPLICATION

This application is based upon and claims the benefit of priority from the prior Japanese Patent Application No. 2024-023771, filed on Feb. 20, 2024, the entire contents of which are incorporated herein by reference.

What is claimed is:

1. A display control system comprising:
a renderer structured to generate a first image that designates color information to be displayed while being superimposed on a predetermined image and a second image that designates transparency of the first image; and
a compositor, wherein
the renderer generates the first image based on data of a first graphical user interface (GUI) object using a GUI component prepared in advance, and generates the second image based on data of a second GUI object that outputs an image that designates transparency of the first GUI object, and
the compositor generates a composite image in which the first image whose transparency is set based on the second image is superimposed on the predetermined image.

2. The display control system according to claim 1, wherein the renderer generates the first image indicating a color obtained by multiplying a color designated for the first GUI object by predetermined transparency.

3. The display control system according to claim 1, wherein the renderer generates one image in which the first image and the second image are disposed in different regions as one image to be transmitted to the compositor.

4. The display control system according to claim 3, further comprising a generator structured to generate layout information including a position of the second image in the one image,
wherein the compositor extracts the first image and the second image from the one image based on the layout information.

5. The display control system according to claim 1, wherein
the renderer is implemented in a first processor, and
the compositor is implemented in a second processor having a safety requirement different from a safety requirement of the first processor.

6. The display control system according to claim 1, wherein
the renderer and the compositor are implemented in a single processor,
the single processor includes a first operating system (OS) on which the renderer operates and a second OS on which the compositor operates, and
the second OS has a safety requirement different from a safety requirement of the first OS.

7. The display control system according to claim 1, wherein
the renderer is implemented in a processor of an information device mounted on a vehicle, and
the compositor is implemented in a processor of a meter device mounted on the vehicle.

8. A display control method executed by a computer, the display control method comprising:
first processing of generating a first image that designates color information to be displayed while being superimposed on a predetermined image and a second image that designates transparency of the first image; and
second processing of generating a composite image in which the first image whose transparency is set based on the second image is superimposed on the predetermined image,
wherein in the first processing, the first image is generated based on data of a first GUI object using a GUI component prepared in advance, and the second image is generated based on data of a second GUI object that outputs an image that designates transparency of the first GUI object.
